(19) United States
(12) Patent Application Publication
(10) Pub. No.: US 2011/0099089 A1
(43) Pub. Date: Apr. 28, 2011

(54) System and Methods for Event Networking, Media Sharing, and Product Creation

(76) Inventor: Gauglitz Wolfram, Dallas, TX (US)

(21) Appl. No.: 12/849,780

(22) Filed: Aug. 3, 2010

Related U.S. Application Data
(60) Provisional application No. 61/231,008, filed on Aug. 3, 2009.

(51) Int. Cl. G06Q 30/00; G06F 15/16

(52) U.S. Cl. 705/27.1; 709/217

(57) ABSTRACT

The present invention relates generally to telecommunications, event networking in the fields of sports and other community events. More particularly, this invention relates to the use of various communications protocols in order to distribute information through a network to enable users to interact and communicate with like-minded users, and to enable the creation and purchasing of customized products.

### FIELD OF THE INVENTION

The present invention relates generally to telecommunications, and event networking in the fields of sports and other community events. More particularly, the invention relates to the use of various communications protocols in order to distribute information through a network to enable users to interact and communicate with like-minded users, and to enable the creation and purchasing of customized products.

### BACKGROUND OF THE INVENTION

Social networking through the internet has exploded of late due to the internet's inherent ability to permit communication among users. Various standard protocols have allowed for information and resource exchange through email, bulletin boards, chat rooms, and the like, for many years, however, more recent advances in mobile technology now permit people to exchange information via their mobile phones that heretofore could take place only while sitting at a desktop, laptop, or notebook computer.

Web-based networking now exists in the form of such sites as MySpace™, Facebook™, LinkedIn™, Twitter™, and others. In such networking sites, users generally join, provide such details as contact information, and optionally include information related to a variety of interests. The sites maintain all information of all users in central servers operably connected to databases, such that users can find each other, establish links to each other, and establish communities of users.

Some social networking sites provide the ability to search for friends, i.e., other users which may already be known to a particular user, or other users who share some commonality in education, employment, or other fields of interest. Users may interact with such friends by posting information to each others' pages maintained on the site, and may also interact by joining in community interactions, such as those provided by applications on sites such as Facebook™.

Some online services offer forums for communication between communities of users. These services include message boards, email lists, chat rooms, personal home pages, and web logs or blogs. See, for example, U.S. Pat. Nos. 6,366,962; 6,363,427. These services provide a forum where profiles or messages are viewed by a specific individual, the general public, or the entire membership of a specific defined group.

These types of forums allow visibility to multiple members of a group; however, they typically are not based on social networks, but rather on broader interests, such as a particular hobby or sport. Identification is either anonymous or via public disclosure of real names, but depiction of connections between people via social networks is generally not provided.

U.S. Pat. No. 6,519,629 discloses, among other things, a system designed to distribute, initiate and allow interaction and communication within like-minded communities of users.

U.S. Pat. No. 6,618,593 discloses a system designed to “match” users using their mobile phones, which may use location and other information to determine such matching.

U.S. Pat. No. 7,047,202 discloses, among other things, a method and apparatus for users to search networks, both their own network and their peers' networks, all under the umbrella of what the inventors therein call a “multiple level access” security system.

U.S. Pat. No. 7,069,308 discloses, among other things, a networking system wherein descriptive data and relationship data are integrated and processed to reveal a series of social relationships connecting any two users within a social network.

In the field of sports, there are many websites of general interest, such as news organizations, and there are those dedicated to the field, which provide a variety of information, such as scores, text descriptions, video clips, photos of games, etc. There are also sites which provide users with games, such as fantasy football, hosted by the site and existing only in cyberspace. Information on local events may be found on the websites for local municipalities, news organizations, sports leagues.

Notwithstanding the myriad sites available for accessing information, none to date provide the ability for users to share media obtained at a sporting event, in real time, such that all users participating in a live event, and those who only take interest at some later time, have access to the combined media from all participants in a customizable manner. The advent of mobile devices capable of reaching the internet, GPS, and audiovisual recording has made it possible to record information at an event and have it be uploaded to a server in essentially realtime. The newest mobile devices, such as the iPhone™ and Blackberry™, are particularly suitable for the purposes of the present invention because they are capable of having applications installed which directly interface with the website servers contemplated by the invention.

None of the prior art methods take advantage of this ability to provide all similarly situated users a shared, continuously updated community view of an event. Nor do they provide the ability to create hard-copy records of such events, obtainable merely by ordering same, whether during the event, immediately thereafter, or any time after the event has completed. The art is in need of such networking tools.

### SUMMARY OF THE INVENTION

It is an object of the invention to overcome the drawbacks of the prior art. The present invention provides the ability not only to generate communities of users, but to offer products tailored and customized for end users. The present invention begins with features commonly found in social networking applications, but adds the ability of purchasing customized products such as T-shirts, enlargements of images, and other items as further described below. These products may be derived from the user's own images uploaded during the event, but also may be derived from other users of the system, as they too are uploading images during the event.

Many a fan has attended a big game, and hoped to leave with a beautiful image of his favorite player, or a key shot of the action. But all too often the fan leaves with little more than a handful of shots, perhaps a few “keepers”, all taken at roughly the same angle. If the fans could easily share all their images, the number of keepers would increase, and the probability of capturing the action shot rises as well. The present invention promotes the collection of a wide variety of images from different angles, and presents users with the ability to create photographic products they would otherwise be unable to obtain anywhere else.

In one aspect, the invention is directed to a method for event networking and product creation having a server and a user database of registered users, the method comprising the steps of:
a) storing images of an event in an event image database, said images being uploaded by a member selected from the group consisting of the registered users, other photographers, and venue cameras;
b) providing access for each registered user to a plurality of images stored by step (a), and allowing each registered user to select from among the images;
c) digitally enhancing the images; and
d) providing to the registered users the ability to purchase a product comprising the enhanced images.

The product may be manufactured by a third party, and sold to a user. In one aspect, the product is a T-shirt, a mug, a photograph, a baseball cap, a poster, a calendar, or a photobook. The stored images may be tagged with information related to at least one of the group consisting of location, camera device, date, and time.

In another aspect, the invention is directed to a system capable of performing the above-described method. Such a system for event networking and product creation may have a server and a user database of registered users, and comprises:
a) an event image database for storage of images, said images being uploaded by a member selected from the group consisting of the registered users, other photographers, and venue cameras;
b) an interface providing access for each registered user to a plurality of images stored by step (a), and allowing each registered user to select from among the images for viewing or inclusion in a product comprising enhanced versions of the images;
c) means for digitally enhancing the images; and
d) production apparatus for producing the product comprising the enhanced images.

The system may produce a variety of products with enhanced images, including a T-shirt, a mug, a photograph, a baseball cap, a poster, a calendar, and a photobook. In one aspect, the images stored in the image database are tagged with information related to at least one of the group consisting of location, camera device, date, and time.

These and other objects are achieved through the present invention as exemplified and further described in the Detailed Description of the Invention below.

### DETAILED DESCRIPTION OF THE INVENTION

The routine features of the implementations described herein are known to those of skill in the art and are therefore not shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the hardware and software components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention is generally described in relation to distribution of information via a network connection. For example, the back-end database may be housed at a remote location on any suitable computer hardware, with operable links to the front-end computer hardware, which ultimately serves information to, and collects information from, end users of the system of the invention. Such hardware is now well known, and any suitable system may be employed, such as the hardware described in U.S. Pat. No. 7,069,308, the disclosure of which is specifically incorporated by reference in its entirety. Furthermore, parts of the system are also in communication with other service providers, over the internet, such that, for example, digital image files may be sent to such service providers for output on hardcopy, such as prints.

By “social network” it is meant an aggregation of individual social relationships, out to any number of degrees of separation. By “user” it is meant an individual who has registered in the system. By “website” it is meant a computer system that serves informational content over a network using the standard protocols of the World Wide Web. As used herein, the term is generally intended to encompass both (i) the hardware/software server components that serve the informational content over the network, and (ii) the “back end” hardware/software components, including any non-standard or specialized components, that interact with the server components to perform services for website users.

Unlike other internet and web-based social networking systems, the advantages of the present invention are found in its ability not only to generate communities of users, but to offer products comprising professionally enhanced images, tailored and customized for the end users and communities. Just as with known social networking systems, users may “meet” and interact via the website produced by the system. Thus, email, chat, bulletin boards, blogs, and other typical forms of social networking are contemplated. However, the present invention adds the ability of purchasing products such as T-shirts, enlargements of images, and other items as further described below. Such products include the typical items one could purchase at a sporting event, but more importantly the products available to users of the system are products employing the collective community of users' images. Thus, the present invention allows for the production of customized products with enhanced images to be produced, sold, and delivered to users in a manner heretofore unavailable.

Registration and Events

In outline, the system of the invention operates as follows. Users register with the system via a website, or as prompted upon launching an application on their mobile device, at which they provide basic information including name and address, billing information, and the like. Also at the time of registration, or any time thereafter, users may identify and select classes of events and/or particular events they would like to follow. Such identification can be performed through searchable lists of events provided by the system based on correlation with the users geographic location as specified by the user. Users may register at home from the desktop, from which they may provide this location and selection information directly on a registration page. Alternatively, they may supply certain information, such as GPS information, via the user's mobile interfacing application, such as an application residing on an iPhone™. Selection of event classes and particular events may occur at any time post-registration as well. Users may also select events that are not already presented in the database through an “add-event” style page accessed from the website or the application on the device.

Events include major sports team games, such as those of the National Football League, Major League Baseball, the National Hockey League, the National Basketball Association, the United States Tennis Association, and others. Additionally, a variety of other national league sports teams, minor league sports teams, and games of local teams such as Little League teams are amenable to the system. In one embodiment, the event is a concert, show, or other public performance. More and more municipalities have cameras installed which would be capable for use in the system. Thus, other municipal and local events, such as parades, town fairs, and the like may be considered events. Additional other events are also included in the invention, including unscheduled events, such as on-scene images of a local fire. Essentially any event for which images can be captured can be shared using the system of the invention, because images thereof will be viewable, and purchaseable, by registered users.

Once an event or class of events is selected, the user's page on the site (whether viewed directly over the internet in a browser or in a mobile application interface) will update with information about upcoming events. For a fan of a particular major team, for example, upcoming games will be displayed on the user's page, as well as related information from the sport, with access to other teams, scores, etc.

Image Collection

When a user attends an event, the user may take images with her phone's camera, and upload the images to the system. Many mobile phones today include location information in tags of digital images, and this information allows the system to not only verify the origin location of the image, but also permits correlation of other users' images uploaded from the same event. Indeed, with improving GPS accuracy, the location of the uploading user may be identified to a specific seat when compared with a map of the stadium or arena in which the game is being played.

The location of events may provide additional opportunities for image collection, as stadiums and arenas may be equipped with cameras capable of being pointed at desired locations throughout the event. For example, the system of the invention contemplates contracting with such venues to provide access by the system to such cameras (or installing them for the venue for use by the system of the invention), such that images of users may be obtained by pointing the cameras to the users' known seat location, as provided by their GPS information. Alternatively, seat information may be provided by the user directly via their device. If necessary to help pinpoint the location of the user, maps of venues may be stored as a database in the system, which thereby will be able to direct cameras of venues to the correct location to collect images of the users, and upload them to the system.

Another source of images is professional photographers, who may be contracted for their services or may be freelance. In either event, such photographers may take images of the event and upload to the system. Additionally, such photographers may be provided with location information for registered users, in which case they may take images of such users, and upload them to the system. These images, which may be tagged with location information, may also be supplied by the photographer with information regarding particular users' locations which were photographed, such that the images will be available be available to each user.

The system then is enabled to allow all registered users at the game to have access to each other's images, thereby providing each user with a variety of angles on the action. Video media is also contemplated as being included for use in the system. When a game concludes, the user has the ability to view her own images, or those of other users who attended the game and uploaded media to the system. Additionally, users may be presented with images taken by the venue's own cameras, or by professional photographers present at the event. Further, as discussed more fully below, because the system is in communication with other service providers, the user may choose to purchase digitally optimized and/or enhanced versions of any of those images by indicating such desire to purchase on the mobile application's interface.

Uploading to the system may be performed in any way capable of transferring images from a device to the system. For example, mobile phones ordinarily provide network connections via HSDPA, GSM, GPRS, EDGE, EVDO, CDMA, and the like. Any of these protocols is suitable for transfer of images, and are thus useful transfer mechanisms. Additionally, WiFi is available on many devices, including many mobile phones, and generally provides a faster transfer mechanism for uploading images. Images may also be transferred after an event, for example, when a user transfers images from an image capture device to a computer which then employs its ordinary internet connection (WiFi, ethernet, etc.) to transfer images to the system.

Many devices store images on memory cards, such as CompactFlash, SD, and the like. While users may transfer images directly from the capture device, where network connection speeds are not sufficiently rapid, users may prefer to simply transfer images to a computer for upload. Similarly, in one embodiment, users may bring their memory cards to an upload station or kiosk in an arena, which provides a suitable location for uploads for users. Such a kiosk may be an output producer, as discussed below, or may be an upload station designed merely for such uploads.

Post-Upload Processing

The system may be made aware of the device which recorded the images, because images are tagged when uploaded to the server with information regarding the device, date and time, location, and the like. Such tag information may be provided by the device itself in many cases, however, where the device does not provide such tags, the user may elect to designate particular devices with the users' profile on the system. In this way, the system knows that the images uploaded by such a user were produced by the device indicated in their profile.

The system may thus also be provided with programmed information about how best to enhance and otherwise optimize the images produced by particular devices to produce superior images and extract the finest image quality possible from such devices. Such enhancement may be automatically applied to the images as they are uploaded to the site, although, to conserve processor power, the enhancement may be performed at later times, such as when the images are selected for output to a product.

Such digital enhancement of images is known to those of skill in the art, however, such enhancement techniques have not been applied automatically and for output to photographic products as contemplated by the invention. Instead, such enhancement techniques have been used in standalone image manipulation programs. It is expected that a variety of image enhancement technology may be applied to the images gathered by the system of the invention. Such enhancement may be applied automatically upon upload, provided sufficient processing power, or may be applied only upon selection of an image for product output.

The invention may use any of a variety of image enhancement technology, such as that disclosed in U.S. Pat. Nos. 6,885,766, 6,954,549, 7,020,330, 7,103,228, and US Patent Application 2004/0086176, each of which is incorporated herein.

In another embodiment, and particularly where all images are enhanced as they are uploaded to the database, the enhanced images may be provided to the arena's staff such that images may be shown in the displays in the stadium. Additionally, enhanced images may be provided to wired and satellite broadcasters for delivery to consumers as a stream to their computer screens, or televisions. Such delivery may take the form of picture-in-picture displays, or may be made available on additional alternative channels.

Devices

The invention may be practiced with a variety of suitable devices, such as Apple Inc.'s iPhone™ and RIM's Blackberry™, and other so-called “smart” phones. However, any mobile device capable of capturing images could be used. For example, it is contemplated that other devices include laptop computers with built in cameras, “netbook” computers with cameras, simple camera phones, digital cameras, digital SLR cameras. Film/slide cameras may also be included as devices useful for the system, provided that users upload digitized versions of such images following film processing.

In another embodiment, a device for use in the system may be designed specifically for use in the system, such that it is capable of at least image capture, but optionally also capable of interfacing with the system via a network.

Product Creation

In one embodiment, single photographs, of a variety of sizes, may be purchased, or the user may select a plurality of photographs to be presented in a photobook, or calendar, or the like, as a keepsake of the event. Other products include greeting cards, postcards, posters, mugs, shirts, and many other products suitable for placement of a photograph. Such purchase instructs the system to direct a service provider to output professionally produced photographs in the format chosen by the user. Where photographic products are desired, any suitable service provider may be used, such as Kodak. Additionally, where professional photographers also participate with the system, a user may opt to include such professional images individually, in an album, in a calendar, or the like. Such professional output may be priced accordingly higher than the user's own photographs, or those of other users attending the game.

In one embodiment, the output products are mailed to the user, so that the user receives the keepsake a day or two after the event has concluded. Alternatively, in another embodiment, the service provider maintains a production unit at the location of the game, so that at the end of the game, the user may purchase the output product immediately.

When the user selects images for output in a product, the user may be presented with the enhanced versions of the chosen images, such that the user can see a preview of the product with the digitally enhanced images already prepared.

While the system of the invention contemplates application to a wide variety of major league sports events, it is equally applicable to local events, school events, and junior leagues. For example, where a little league baseball league (or team) desires to use the system, pages are constructed on the website and in mobile applications where users who are members of the league may follow the league's games. At each game, users may upload photographs of the game, and, just as with major league events, users may purchase professionally produced photographs, albums, calendars, and the like. The system thus accomplishes several objectives: it allows users to obtain customized professionally produced photographic products from their own images as well those of other league member users, professional photographers, and where available, cameras at the venue itself; it allows for viewing of such images on mobile devices as well as desktop computers; and it may replace the need for teams to hire photographers for keepsake photographs of the teams and players.

Users need not even be capturing their own images at the event, because users will have access to images taken by other users, professional photographers, and venue cameras, from which to design and purchase a product.

In one embodiment of the invention, images uploaded by users are tagged by the users with a status, either private, to be held in the user's account alone, or public, to be shared with the community. The public status may offer further granularity, in that it may be public to the event's community, or public to the website as a whole.

With each event, the database archives all the images for the event, thereby allowing users to view the images and order products immediately after the event, or days, months, even years later. The system grows as more events are added to the database, so that entire seasons of events are available to users. Thus, users may “mix and match” to format their desired products. For example, a user may select twelve images from different events to create a calendar, with an image chosen for each month.

A variety of templates are available on the system, but users may also save as templates products they create, and designate them as public in the same way photographs may be so designated, so that the community shares in the creativity of its users. Such templates may be offered to the public, or the system can be provided with a means for user-created templates to be available to other users for a fee. Such fee may be shared by the owner of the system with the user who created the template, thereby providing a mechanism by which users who create templates share in the benefits provided to the entire community.

Other embodiments, uses, and advantages of the present invention will be apparent to those skilled in the art from consideration of the specification and practice of the invention disclosed herein. The specification and examples should be considered exemplary only. The intended scope of the invention is only limited by the claims appended hereto.

### EXAMPLES

The present invention will be further understood by reference to the following non-limiting examples.

### Example 1

### An Embodiment of the Invention, As Applied to a Sporting Event

Each user may customize their copy of the installed mobile application on their device for listings of events taking place within a particular geographic radius, and a time frame. In this example, football fan users have registered, and installed the application on their iPhones™ and Blackberrys™. The application lists events fitting the set criteria, and the user may tap the items listed for further information. Users may also access the server for searching for events based on type of event, organization, dates, geographic locations, and other relevant criteria.

Registered users of the system attend a football game, the Philadelphia Eagles versus the Dallas Cowboys at Lincoln Financial Field in Philadelphia. Upon arrival at the stadium, the users find their way to their seats and get ready for the game by launching the application previously installed on their mobile phones, such as iPhones™ and Blackberrys™. The application launches, and each user is presented with a screen customized with information relevant to their user accounts. For those users who previously identified either the Eagles or the Cowboys as a team to follow, an alert appears informing them that there is a game about to take place. For those whose GPS units are activated, the system recognizes that they are in fact at the game.

The users take photographs during the game, uploading them to the system throughout, and designating each photograph as private or public. Upon upload, the system determines the location from which the photograph was taken based on the location tags found in the digital image file, if present. Date and time stamp information, also found in tags in the file, are also collected by the system. The model of mobile device taking the photograph is also either tagged in the digital photographic files, or is input by the user as part of the user account or entered upon launching of the application on the device.

The system is aware of the device which recorded the images, and thus may optimize the images, extracting the finest image quality possible from such devices.

In the case of devices having tappable touchscreen interfaces, the application has tappable areas to review images already taken, those uploaded, those designated private and those designated public. Another tappable area links to photographs taken by other users at the game, showing thumbnails of others' public photographs. The name of the user who uploaded the photograph may (or may not) be listed below each thumbnail. Tapping on the thumbnail opens a page showing all public photographs uploaded by that user. Each photograph has a tappable area which the user can tap to save it for use in photographic products to be purchased later. Each image may also be rated by the users, allowing for an additional tappable area which leads to the most highly rated images. While the basic operation of the application has been described for a touchscreen interface, other interfaces may be employed which rely on selection with buttons or the like.

Personalized photographic products may be created through the mobile device application using a variety of templates made available to the application, as well as personalized templates created by the user, whether such templates have been created on the web and sent to the device by the server's front end, or even created on the mobile device itself through a feature of the application. In some embodiments of this example, a user may offer a personalized photographic product for sale to any others in the network, for which that user would receive a percentage of such sales. Such transactions may be handled by the system.

An indicator may be present in one area of the screen showing how many other users are using the system at an event. Another tappable area can be tapped to bring up a schematic view of the stadium, with indicators showing where other uploading users are located.

Users continue to take images, and upload them to the system. Additionally, professional photographers take and upload images, both images of the game itself as well as images of particular users, tagged with the users' name, location, or other data tag capable of indicating which user was imaged. The stadium also has cameras trained on the game and the seats, and in cooperation with the owner of the system of the invention, and for a fee, these cameras are pointed at registered users throughout the game, capturing images and uploading them to the system with a tag indicating which user was imaged. The system is then able to associate all images of any particular user with that users' account, and thus provide all images a user may be interested in when the user reviews images for purchase of products.

Some users may decide to order products during the game, for example, a T-shirt with a favorite image already captured by the user or another user, a coffee mug with such an image, or a photobook. Other users may wait until they get home to review the events' images on the website, and prepare a more formal photobook. Either way, the purchase choices are made, payment information is entered, and the transaction proceeds. The system prepares directs products to be created by third party vendors from the images chosen by the user, however, the images are first enhanced such that maximum quality images are used for the production of such products. Products are then prepared and shipped to the users' home within a few days.

### Example 2

### An Extension of Example 1

In this Example, the event is the same as in Example 1, however, a photographic product company has a kiosk at the stadium, and is enabled to print T-shirts, mugs, enlargement photographs, and optionally calendars, photobooks, and other products. The kiosk also has a computer connected to the internet, such that registered users with memory cards may upload to the system at any time, and such that the kiosk has access to the images in the database.

Users who order product items may select to have the items printed at the stadium, for a fee which may be different from the fee charged for items produced and shipped to their homes. Thus, one user orders an enlargement of a favorite image taken during the first quarter, and during halftime he proceeds to the kiosk where he picks up the enlargement. Another user orders a T-shirt just before halftime, and picks up the T-shirt later during the game. In either case, the images have been enhanced such that maximum quality images are used to prepare the end products.

The present invention is not to be limited in scope by the specific embodiments described above, which are intended as illustrations of aspects of the invention. Functionally equivalent methods and components are within the scope of the invention. Indeed, various modifications of the invention, in addition to those shown and described herein, will become apparent to those skilled in the art from the foregoing description. Such modifications are intended to fall within the scope of the appended claims. All cited references are hereby incorporated by reference.

We claim:

1. A method for event networking and product creation having a server and a user database of registered users, the method comprising the steps of:
a) storing images of an event in an event image database, said images being uploaded by a member selected from the group consisting of the registered users, other photographers, and venue cameras;
b) providing access for each registered user to a plurality of images stored by step (a), and allowing each registered user to select from among the images;
c) digitally enhancing the images; and
d) providing to the registered users the ability to purchase a product comprising the enhanced images.

2. The method of claim, further comprising the step of
e) manufacturing the product.

3. The method of claim 2, wherein step (e) is performed by a third party.

4. The method of claim 2, wherein the product is selected from the group consisting of a T-shirt, a mug, a photograph, a baseball cap, a poster, a calendar, and a photobook.

5. The method of claim 1, wherein the images stored in step (a) are tagged with information related to at least one of the group consisting of location, camera device, date, and time.

6. A system for event networking and product creation having a server and a user database of registered users, the system comprising:
a) an event image database for storage of images, said images being uploaded by a member selected from the group consisting of the registered users, other photographers, and venue cameras;
b) an interface providing access for each registered user to a plurality of images stored by step (a), and allowing each registered user to select from among the images for viewing or inclusion in a product comprising enhanced versions of the images;
c) means for digitally enhancing the images; and
d) production apparatus for producing the product comprising the enhanced images.

7. The system of claim 6, wherein the product is selected from the group consisting of a T-shirt, a mug, a photograph, a baseball cap, a poster, a calendar, and a photobook.

8. The system of claim 6, wherein the images stored in the image database are tagged with information related to at least one of the group consisting of location, camera device, date, and time.
